(19) United States
(12) Patent Application Publication
(10) Pub. No.: US 2018/0183070 A1
(43) Pub. Date: Jun. 28, 2018

(54) HYBRID CATALYST FOR FUEL CELLS AND METHOD FOR MANUFACTURING THE SAME

(71) Applicant: HYUNDAI MOTOR COMPANY, Seoul (KR)

(72) Inventors: Ju Hee LEE, Seoul (KR); Won Jung KIM, Seoul (KR)

(21) Appl. No.: 15/591,658

(22) Filed: May 10, 2017

(30) Foreign Application Priority Data
Dec. 22, 2016 (KR) 10-2016-0176655

(51) Int. Cl. H01M 4/92; H01M 4/88

(52) U.S. Cl. CPC H01M 4/926; H01M 4/8882; H01M 4/8825

(57) ABSTRACT

A hybrid catalyst for a fuel cell includes a noble metal-based catalyst; and a non-noble metal-based catalyst on which the noble metal-based catalyst is supported. The noble metal-based catalyst comprises at least one of platinum (Pt), palladium (Pd), iridium (Ir), and gold (Au). The noble metal-based catalyst comprises a porous carbon having a first pore and a second pore smaller than the first pore.

### CROSS-REFERENCE TO RELATED APPLICATION(S)

This application claims the benefit of priority to Korean Patent Application No. 10-2016-0176655, filed on Dec. 22, 2016 in the Korean Intellectual Property Office, the entire disclosure of which is incorporated herein by reference.

### TECHNICAL FIELD

The present disclosure relates to a hybrid catalyst used as an electrode material for fuel cells and a method for manufacturing the same, and more particularly, to a hybrid catalyst in which a chemically noble metal is supported on a chemically non-noble metal-based catalyst and a method for manufacturing the same.

### BACKGROUND

Vehicles using proton exchange membrane fuel cells (PEMFCs) are eco-friendly since hydrogen gas is used as a fuel and water is produced as a byproduct at a relatively low temperature below 80° C. Thus, research on PEMFCs for automotive, industrial, and home applications has been conducted.

In conventional PEMFCs, fine metal particles of a chemically noble metal with excellent catalytic activity and high electrode potential, for example, platinum for a main ingredient, have been widely used as an electrode catalyst.

However, since platinum is a rare and high-cost metal, there is a need to develop alternative catalysts for fuel cell electrodes having high activity using a less amount of platinum than conventional catalysts.

### SUMMARY

An aspect of the present disclosure provides a hybrid catalyst for fuel cells in which a platinum catalyst is supported on a non-noble metal-based catalyst, and a method for manufacturing the same. In this regard, the non-noble metal-based catalyst may be a non-noble metal-based catalyst having catalytic active sites selectively formed on surfaces of micro pores.

Additional aspects of the disclosure will be set forth in part in the description which follows and, in part, will be obvious from the description, or may be learned by practice of the disclosure.

One aspect of the present disclosure, a hybrid catalyst is provided for a fuel cell. The hybrid catalyst includes a noble metal-based catalyst; and a non-noble metal-based catalyst on which the noble metal-based catalyst is supported.

The noble metal-based catalyst may comprise at least one of platinum (Pt), palladium (Pd), iridium (Ir), and gold (Au).

The non-noble metal-based catalyst may comprise a porous carbon having a first pore and a second pore smaller than the first pore, wherein the first pore has a pore size of 5 to 100 nm, and a non-noble metal catalytic active site is introduced into an inner wall of the first pore.

The noble metal-based catalyst may be supported on the surface of the first pore of the non-noble metal-based catalyst.

The porous carbon may have a structure in which the first pore and the second pore are uniformly connected in a three-dimensional space.

The first pore may have a pore size of 15 to 60 nm.

The non-noble metal catalytic active site may be represented by Formula 1 below:

1MₓN_{y} Formula 1

where x is an integer from 0 to 1, y is an integer from 1 to 4, and M is a transition metal.

The non-noble metal catalytic active site may be formed by a non-noble metal-based catalyst precursor.

The non-noble metal-based catalyst precursor may have a form in which at least one of phthalocyanine, phthalocyanine tetrasulfonate, octabutoxy phthalocyanine, hexadecafluoro phthalocyanine, octakis octyloxy phthalocyanine, tetra-tert-butyl phthalocyanine, tetraaza phthalocyanine, tetraphenoxy phthalocyanine, tetra-tert-butyl tetrakis dimethylamino phthalocyanine, tetrakis cumylphenoxy phthalocyanine, tetrakis pyridiniomethyl phthalocyanine, tetranitrophthalocyanine, naphthalocyanine, tetra-tert-butyl naphthalocyanine, tetraphenyl porphine, tetrakis pentafluorophenyl porphyrin, tetrakis methylpyridinio porphyrin tetratoluenesulfonate, tetrakistrimethylammoniophenyl porphyrin tetratoluenesulfonate, tetramethyl divinyl porphinedipropionic acid, tetrapyridyl porphine, octaethyl porphyrin, tetrakis methoxyphenyl porphine, tetraphenylporphine tetracarboxylic acid, tetrakis hydroxyphenyl porphine, tetrakis sulfonatophenyl porphine, etioporphyrin, 1,10-phenanthroline, 1,10-phenanthroline-5,6-dionedimethyl-1,10-phenanthroline, dimethyl-1,10-phenanthroline, dimethoxy-1,10-phenanthroline, dimethoxy-1,10-phenanthroline, amino-1,10-phenanthroline, methyl-1,10-phenanthroline, dihydroxy-1,10-phenanthroline, tetramethyl-1,10-phenanthroline, chloro-1,10-phenanthroline, dichloro-1,10-phenanthroline, nitro-1,10-phenanthroline, bromo-1,10-phenanthroline, tetrabromo-1,10-phenanthroline, pyrazino[1,10]phenanthroline, diphenyl-1,10-phenanthroline, dimethyl diphenyl-1,10-phenanthroline, ethenyl formyl(hydroxy trimethyltetradecyl) trimethyl porphine dipropanoato, diethenyl tetramethyl porphine dipropanoato, bis((amino carboxyethyl)thio)ethyl tetramethyl porphine dipropanoato, dihydro dihydroxy tetramethyl divinyl porphine dipropionic acid lactonato, ethenyl(hydroxy trimethyl tetradecatrienyl) tetramethyl porphine dipropanoato, carboxyethenyl carboxyethyl dihydro bis(hydroxymethyl) tetramethyl porphine dicarboxylato, dimethylbenzimidazolyl)cyanocobamide, curtis macrocycle, Jäger macrocycle and DOTA macrocycle, is coordinated to a metal.

The metal may comprise at least one transition metal selected from iron (Fe), cobalt (Co), manganese (Mn), nickel (Ni), and chromium (Cr).

A mass fraction of the transition metal comprised in the non-noble metal-based catalyst precursor may be in the range of 1 to 50 wt % based on a total weight of the porous carbon.

An anchoring site may be introduced into a surface of a pore of the porous carbon to enhance interactions between the porous carbon and the non-noble metal-based catalyst precursor.

Another aspect of the present disclosure, there is provided a method for manufacturing a hybrid catalyst for a fuel cell. The method may comprise adding a non-noble metal-based catalyst and a noble metal-based catalyst to an ethylene glycol solution and dispersing a mixed solution; and sonicating the mixed solution.

The method may further comprise purging the ethylene glycol solution in an inert gas atmosphere.

The adding of the non-noble metal-based catalyst and a noble metal-based catalyst to the ethylene glycol solution and dispersing the mixed solution may comprise adding a non-noble metal-based catalyst to an ethylene glycol solution and dispersing a mixture thereof, and adding a noble metal-based catalyst to the mixture and dispersing a resultant mixture thereof.

The sonicating of the mixed solution may comprise sonicating the mixed solution for 1 to 3 hours.

The method may comprise filtering the mixed solution; and washing and drying a filtered product.

The method may comprise preparing the non-noble metal-based catalyst, wherein the preparing of the non-noble metal-based catalyst comprises: mixing a porous carbon with a non-noble metal-based catalyst precursor; heat-treating a mixture thereof at a temperature of 600 to 1200° C.; stirring the heat-treated mixture in an acidic solution; and washing and drying the stirred mixture.

The porous carbon may have a first pore and a second pore smaller than the first pore, and the first pore has a pore size of 5 to 100 nm in the mixing of the porous carbon with the non-noble metal-based catalyst precursor.

The first pore may have a pore size of 15 to 60 nm.

The method may further comprise heat-treating solid powder acquired after the drying in an ammonia (NH₃) gas atmosphere at a temperature of 600 to 1200° C. for 5 to 60 minutes.

The method may further comprise forming an anchoring site on a surface of a pore of the porous carbon by heat-treating the porous carbon in an ammonia (NH₃) gas atmosphere at a temperature of 600 to 1200° C. for 5 to 60 minutes.

The non-noble metal-based catalyst precursor may have a form in which at least one of phthalocyanine, phthalocyanine tetrasulfonate, octabutoxy phthalocyanine, hexadecafluoro phthalocyanine, octakis octyloxy phthalocyanine, tetra-tert-butyl phthalocyanine, tetraaza phthalocyanine, tetraphenoxy phthalocyanine, tetra-tert-butyl tetrakis dimethylamino phthalocyanine, tetrakis cumylphenoxy phthalocyanine, tetrakis pyridiniomethyl phthalocyanine, tetranitrophthalocyanine, naphthalocyanine, tetra-tert-butyl naphthalocyanine, tetraphenyl porphine, tetrakis pentafluorophenyl porphyrin, tetrakis methylpyridinio porphyrin tetratoluenesulfonate, tetrakistrimethylammoniophenyl porphyrin tetratoluenesulfonate, tetramethyl divinyl porphinedipropionic acid, tetrapyridyl porphine, octaethyl porphyrin, tetrakis methoxyphenyl porphine, tetraphenylporphine tetracarboxylic acid, tetrakis hydroxyphenyl porphine, tetrakis sulfonatophenyl porphine, etioporphyrin, 1,10-phenanthroline, 1,10-phenanthroline-5,6-dionedimethyl-1,10-phenanthroline, dimethyl-1,10-phenanthroline, dimethoxy-1,10-phenanthroline, dimethoxy-1,10-phenanthroline, amino-1,10-phenanthroline, methyl-1,10-phenanthroline, dihydroxy-1,10-phenanthroline, tetramethyl-1,10-phenanthroline, chloro-1,10-phenanthroline, dichloro-1,10-phenanthroline, nitro-1,10-phenanthroline, bromo-1,10-phenanthroline, tetrabromo-1,10-phenanthroline, pyrazino[1,10]phenanthroline, diphenyl-1,10-phenanthroline, dimethyl diphenyl-1,10-phenanthroline, ethenyl formyl(hydroxy trimethyltetradecyl) trimethyl porphine dipropanoato, diethenyl tetramethyl porphine dipropanoato, bis((amino carboxyethyl)thio)ethyl tetramethyl porphine dipropanoato, dihydro dihydroxy tetramethyl divinyl porphine dipropionic acid lactonato, ethenyl(hydroxy trimethyl tetradecatrienyl) tetramethyl porphine dipropanoato, carboxyethenyl carboxyethyl dihydro bis(hydroxymethyl) tetramethyl porphine dicarboxylato, dimethylbenzimidazolyl)cyanocobamide, curtis macrocycle, Jäger macrocycle and DOTA macrocycle, is coordinated to a metal, in the mixing of the porous carbon with the non-noble metal-based catalyst precursor.

The metal may comprise at least one transition metal selected from iron (Fe), cobalt (Co), manganese (Mn), nickel (Ni), and chromium (Cr).

The non-noble metal-based catalyst precursor may comprise a transition metal in a mass fraction of 1 to 50 wt % based on a total weight of the porous carbon in the mixing of the porous carbon with the non-noble metal-based catalyst precursor.

The heat-treating of the mixture at a temperature of 600 to 1200° C. may comprise heat-treating the mixture in an inert gas atmosphere at a temperature of 600 to 1200° C. for 10 to 300 minutes.

The stirring of the heat-treated mixture in the acidic solution may comprise adding the heat-treated mixture to an acidic solution having a concentration of 0.1 M or greater and stirring the resultant mixture.

### BRIEF DESCRIPTION OF THE DRAWINGS

These and/or other aspects of the present disclosure will become apparent and more readily appreciated from the following description of the embodiments, taken in conjunction with the accompanying drawings in which:

FIG. 1 is a schematic cross-sectional view of a hybrid catalyst for fuel cells according to an embodiment.

FIG. 2 is an enlarged view of a portion AA of FIG. 1.

FIG. 3 is a transmission electron microscopic (TEM) image illustrating a structure of MSUFC porous carbon.

FIG. 4 is a graph illustrating pore size distribution of micropores of the MSUFC porous carbon.

FIG. 5 is a graph illustrating pore size distribution of ultrafine pores of the MSUFC porous carbon.

FIG. 6 is a TEM image illustrating a structure of a synthesized non-noble metal-based catalyst.

FIG. 7 is a graph illustrating pore size distribution of micropores of the non-noble metal-based catalyst.

FIG. 8 is a diagram schematically illustrating reaction taking place on the surface of a pore of the porous carbon into which an anchoring site is not introduced.

FIG. 9 is a diagram schematically illustrating reaction taking place on the surface of a pore of the porous carbon into which an anchoring site is introduced.

FIG. 10 is a diagram schematically illustrating a structure in which a noble metal-based catalyst is supported on a non-noble metal-based catalyst in a hybrid catalyst according to an embodiment.

FIG. 11 is a schematic diagram illustrating a process of manufacturing a hybrid catalyst according to an embodiment.

FIGS. 12 and 13 are flowcharts for describing the process of manufacturing the hybrid catalyst.

FIG. 14 is a graph illustrating results of oxygen reduction reaction (ORR) with respect to the types of the non-noble metal-based catalyst precursor.

FIG. 15 is a graph illustrating results of ORR depending on introduction of anchoring sites.

FIG. 16 is a graph illustrating results of ORR with respect to heat-treatment conditions.

FIG. 17 is a diagram illustrating a non-noble metal catalytic active site A formed in a second pore H2.

FIG. 18 is a TEM image illustrating the catalyst sample according to Comparative Example 1.

FIG. 19 is a TEM image illustrating the non-noble metal based catalyst sample according to Comparative Example 2.

FIG. 20 is a TEM image illustrating the hybrid catalyst sample according to Example 1.

FIG. 21 is a graph illustrating cyclic voltammetry curves of the catalysts prepared according to Example 1 and Comparative Examples 1 and 2.

FIGS. 22 and 23 are graphs illustrating ORR curves of the catalysts prepared according to Example 1 and Comparative Examples 1 and 2.

### DETAILED DESCRIPTION

Reference will now be made in detail to the embodiments of the present disclosure, examples of which are illustrated in the accompanying drawings. In the drawings, the same or similar elements are denoted by the same reference numerals even though they are depicted in different drawings. In the following description of the present disclosure, a detailed description of known functions and configurations incorporated herein will be omitted when it may make the subject matter of the present disclosure rather unclear.

Further, it is to be understood that the terms “include” or “have” are intended to indicate the existence of elements disclosed in the specification, and are not intended to preclude the possibility that one or more other elements may exist or may be added.

In this specification, terms “first,” “second,” etc., are used to distinguish one component from other components and, therefore, the components are not limited by the terms.

An expression used in the singular encompasses the expression of the plural, unless it has a clearly different meaning in the context.

The reference numerals used in operations are used for descriptive convenience and are not intended to describe the order of operations and the operations may be performed in a different order unless otherwise stated.

The present disclosure relates to a hybrid catalyst of platinum (Pt) and a non-platinum metal used as an electrode material of fuel cells.

The hybrid catalyst according to an embodiment is used in oxygen reduction reaction (ORR) taking place in cathodes of proton exchange membrane fuel cells (PEMFCs). The hybrid catalyst is provided in a form in which a Pt catalyst is supported on a nanoporous non-noble metal-based catalyst having a uniform structure. Since a non-noble metal-based catalyst having Fe—N—C active sites is used as a support of a Pt catalyst according to an embodiment, the same catalytic activity may be acquired using a less amount of the Pt catalyst than those of conventional catalysts.

The non-noble metal-based catalyst applied to the hybrid catalyst of the present disclosure may be prepared by doping a carbon composite having macro pores on the surface thereof with a non-noble metal-based catalyst precursor. As a result, manufacturing costs may be reduced in comparison with conventional Pt catalysts, and mass transfer resistance may also be reduced in membrane electrode assemblies (MEAs) by providing the non-noble metal-based catalyst having a pore size of several tens of nanometers.

Hereinafter, embodiments of the present disclosure will be described in detail with reference to the accompanying drawings.

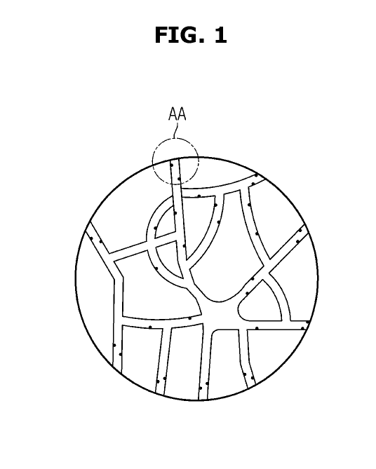

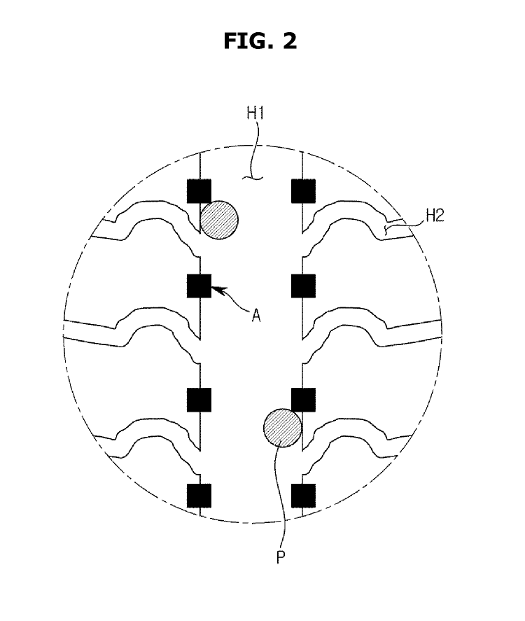

FIG. 1 is a schematic cross-sectional view of a hybrid catalyst for fuel cells according to an embodiment. FIG. 2 is an enlarged view of a portion AA of FIG. 1.

Referring to FIGS. 1 and 2, a hybrid catalyst for fuel cells according to an embodiment has a structure in which a noble metal-based catalyst is loaded on inner walls of a non-noble metal-based catalyst having non-noble metal catalytic active sites.

In general, an electrode catalyst for fuel cells has a structure in which a noble metal-based catalyst is supported on the surface of a porous carbon support. However, the hybrid catalyst according to an embodiment has a structure in which a noble metal-based catalyst is supported on a non-noble metal-based catalyst. Thus, the same catalytic activity may be achieved according to an embodiment with a less amount of the Pt catalyst than that of conventional catalysts.

The noble metal-based catalyst includes at least one of platinum (Pt), palladium (Pd), iridium (Ir), and gold (Au). Hereinafter, the embodiment will be described based on a Pt catalyst for descriptive convenience.

The non-noble metal-based catalyst may be provided in a form in which a non-noble metal-based catalyst precursor is doped in a porous carbon structure, in other words, non-noble metal catalytic active sites A are formed via introduction of a non-noble metal-based catalyst precursor into a carbon network structure of porous carbon.

As the porous carbon, a porous carbon material having pores may be used. The pores on the surface of the porous carbon may include first pores H1 and second pores H2 smaller than the first pores H1. More particularly, the first pores H1 of the porous carbon may have a pore size of 5 to 100 nm, preferably, 15 to 50 nm. The second pores H2 may have a smaller pore size than those of the first pores H1, among which the smallest pore size obtained during the preparation of the porous carbon ranges several nanometers. Throughout the specification, the first pores H1 may be referred to as “micropores”, and the second pores H2 may be referred to as “ultrafine pores.”

The Pt catalyst P may be supported on surfaces of the first pores H1 of the non-noble metal-based catalyst. This is because, a size of the Pt catalyst P is smaller than those of the first pores H1 and greater than those of the second pores H2. Thus, the Pt catalyst P may be efficiently supported on the surface of the non-noble metal-based catalyst.

The first pores H1 and the second pores H2 may form a uniformly connected structure in a three-dimensional space. Hereinafter, a structure of the porous carbon and pore size distribution data thereof will be described based on MSUFC porous carbon used herein.

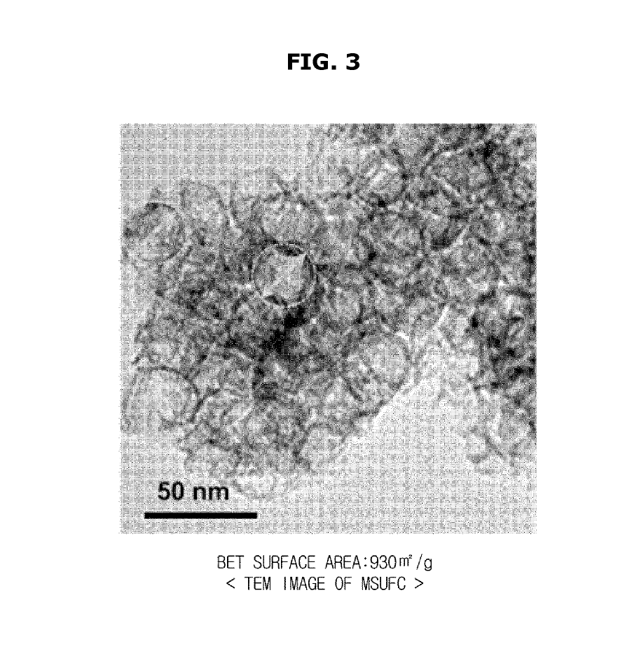

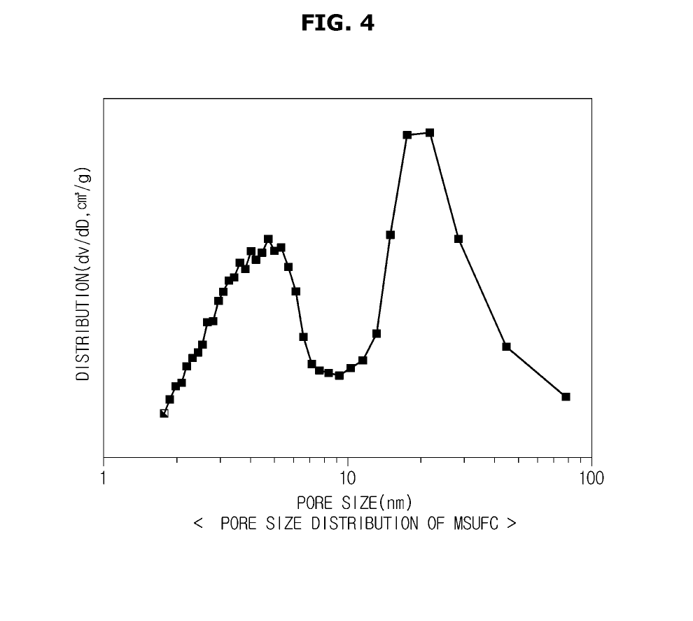

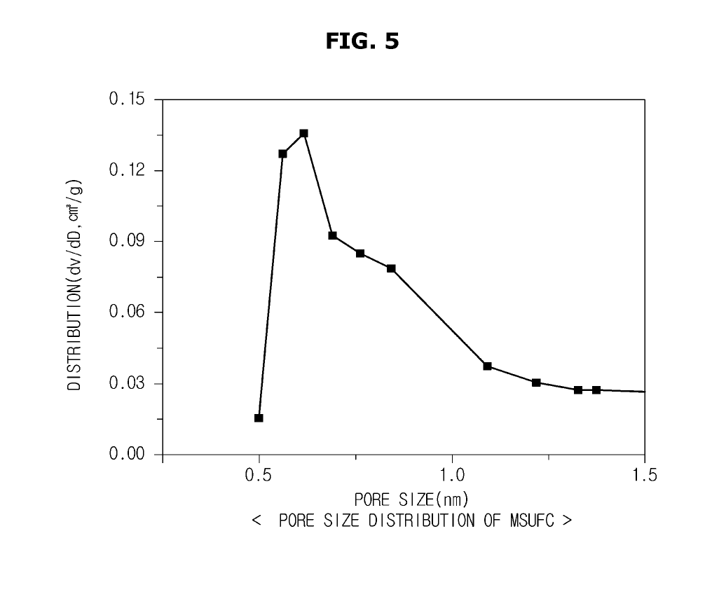

FIG. 3 is a transmission electron microscopic (TEM) image illustrating a structure of MSUFC porous carbon. FIG. 4 is a graph illustrating pore size distribution of micropores of the MSUFC porous carbon. FIG. 5 is a graph illustrating pore size distribution of ultrafine pores of the MSUFC porous carbon.

Referring to FIGS. 3 and 4, it is confirmed that micropores having a pore size approximately of 5 to 100 nm (with a main distribution range approximately of 15 to 60 nm) are formed on the surface of the MSUFC porous carbon and a channel having a size approximately of 2 to 10 nm is formed therein. Further, referring to FIGS. 3 and 5, it may be confirmed that ultrafine pores having a pore size approximately of 0.5 to 1.5 nm are formed on the surface of the MSUFC porous carbon.

In general, if the pore size of the porous carbon is less than 15 nm, mass transfer resistance may increase. If the pore size of the porous carbon is greater than 60 nm, specific surface area of the porous carbon may decrease. Thus, the first pores having a pores size of 5 to 100 nm, preferably, 5 to 60 nm, may be introduced into the carbon structure according to an embodiment to obtain satisfactory mass transfer resistance and specific surface area.

Non-noble metal catalytic active sites are formed on the inner walls of the first pores of the porous carbon as illustrated in FIG. 3. The non-noble metal catalytic active sites may be formed by using a non-noble metal-based catalyst precursor. According to the present embodiment, a non-noble metal-based catalyst precursor having a diameter less than those of the first pores and greater than those of the second pores may be used to control conditions for the manufacturing process, such that the active sites of the non-noble metal-based catalyst are selectively formed on the inner surfaces of the first pores.

For example, if iron phthalocyanine having a diameter approximately of 1.2 nm is used as the non-noble metal-based catalyst precursor, most of the second pores are smaller than the non-noble metal-based catalyst precursor, and thus, almost all of the non-noble metal-based catalyst precursor may interact with the surfaces of the first pores to selectively form the catalytic active sites on the inner walls of the first pores. Since the channel of the porous carbon has a size approximately of 2 to 10 nm as described above, the catalytic active sites may also be partially formed on the inner walls of the channel.

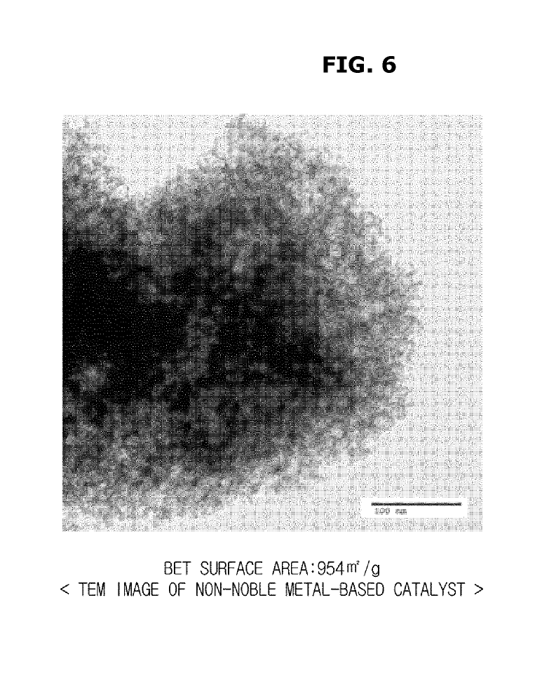

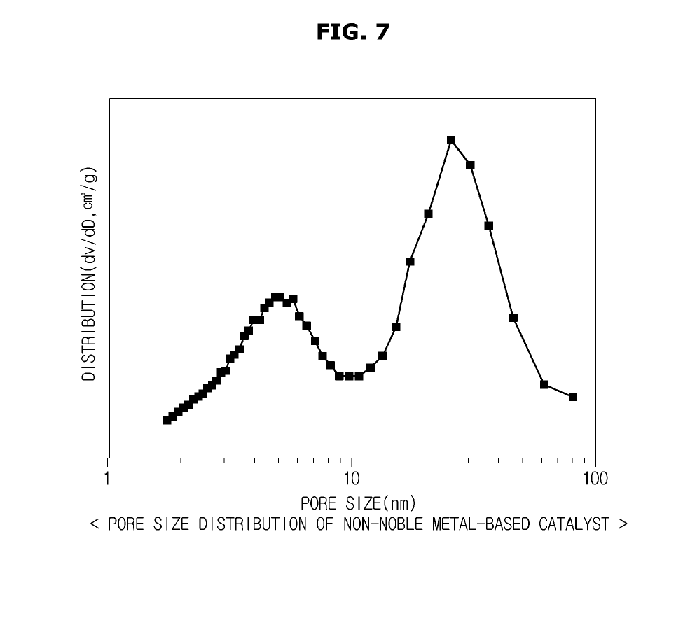

FIG. 6 is a TEM image illustrating a structure of a synthesized non-noble metal-based catalyst. FIG. 7 is a graph illustrating pore size distribution of micropores of the non-noble metal-based catalyst.

FIGS. 6 and 7 illustrate results of experiments in case of using iron phthalocyanine as the non-noble metal-based catalyst precursor.

The results shown in FIGS. 6 and 7 are compared with those shown in FIGS. 3 and 4. In case of the non-noble metal-based catalyst according to an embodiment in which the porous carbon is doped with the non-noble metal-based catalyst precursor, it may be confirmed that the distribution of pores decreases after doping the porous carbon with the non-noble metal-based catalyst precursor. Thus, it may be confirmed that the non-noble metal-based catalyst precursor is doped into the surfaces of the channel structure and the first pores of the porous carbon and the active sites are formed thereon.

The non-noble metal-based catalyst precursor may have a form in which at least one of phthalocyanine, phthalocyanine tetrasulfonate, octabutoxy phthalocyanine, hexadecafluoro phthalocyanine, octakis octyloxy phthalocyanine, tetra-tert-butyl phthalocyanine, tetraaza phthalocyanine, tetraphenoxy phthalocyanine, tetra-tert-butyl tetrakis dimethylamino phthalocyanine, tetrakis cumylphenoxy phthalocyanine, tetrakis pyridiniomethyl phthalocyanine, tetranitrophthalocyanine, naphthalocyanine, tetra-tert-butyl naphthalocyanine, tetraphenyl porphine, tetrakis pentafluorophenyl porphyrin, tetrakis methylpyridinio porphyrin tetratoluenesulfonate, tetrakistrimethylammoniophenyl porphyrin tetratoluenesulfonate, tetramethyl divinyl porphinedipropionic acid, tetrapyridyl porphine, octaethyl porphyrin, tetrakis methoxyphenyl porphine, tetraphenylporphine tetracarboxylic acid, tetrakis hydroxyphenyl porphine, tetrakis sulfonatophenyl porphine, etioporphyrin, 1,10-phenanthroline, 1,10-phenanthroline-5,6-dionedimethyl-1,10-phenanthroline, dimethyl-1,10-phenanthroline, dimethoxy-1,10-phenanthroline, dimethoxy-1,10-phenanthroline, amino-1,10-phenanthroline, methyl-1,10-phenanthroline, dihydroxy-1,10-phenanthroline, tetramethyl-1,10-phenanthroline, chloro-1,10-phenanthroline, dichloro-1,10-phenanthroline, nitro-1,10-phenanthroline, bromo-1,10-phenanthroline, tetrabromo-1,10-phenanthroline, pyrazino[1,10]phenanthroline, diphenyl-1,10-phenanthroline, dimethyl diphenyl-1,10-phenanthroline, ethenyl formyl(hydroxy trimethyltetradecyl) trimethyl porphine dipropanoato, diethenyl tetramethyl porphine dipropanoato, bis((amino carboxyethyl)thio)ethyl tetramethyl porphine dipropanoato, dihydro dihydroxy tetramethyl divinyl porphine dipropionic acid lactonato, ethenyl(hydroxy trimethyl tetradecatrienyl) tetramethyl porphine dipropanoato, carboxyethenyl carboxyethyl dihydro bis(hydroxymethyl) tetramethyl porphine dicarboxylato, dimethylbenzimidazolyl)cyanocobamide, curtis macrocycle, Jäger macrocycle and DOTA macrocycle, is coordinated to a metal ion. Here, the metal may include at least one transition metal selected from iron (Fe), cobalt (Co), manganese (Mn), nickel (Ni), and chromium (Cr).

The types of the non-noble metal-based catalyst precursor are not limited thereto and may also be understood broadly as a concept including modifications within a range obvious to those of ordinary skill in the art.

The non-noble metal-based catalyst precursor may include the transition metal in a mass fraction of 1 to 50 wt % based on a total weight of the porous carbon.

If the mass fraction of the transition metal is less than 1 wt % based on the total weight of the porous carbon, the catalytic active sites may not be appropriately formed. If the mass fraction of the transition metal is greater than 50 wt % based on the total weight of the porous carbon, all of the non-noble metal-based catalyst precursor cannot enter the first pores of the porous carbon and may remain on the surface of the porous carbon. Thus, the mass fraction of the transition metal needs to be adjusted based on the total weight of the porous carbon.

Furthermore, the porous carbon may have anchoring sites introduced into the surfaces of the pores of the porous carbon according to an embodiment to increase interactions between the porous carbon and the non-noble metal-based catalyst precursor. A process of introducing the anchoring sites into the surfaces of the pores of the porous carbon may include doping the surface of the porous carbon with nitrogen atoms in various manners before doping the surface of the porous carbon with the non-noble metal-based catalyst precursor.

Hereinafter, probability of catalytic active site formation when anchoring sites are introduced or not introduced into the pore surfaces of the porous carbon will be described with reference to the accompanying drawings.

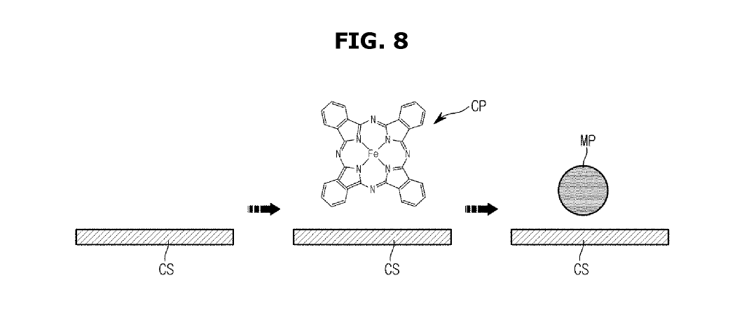

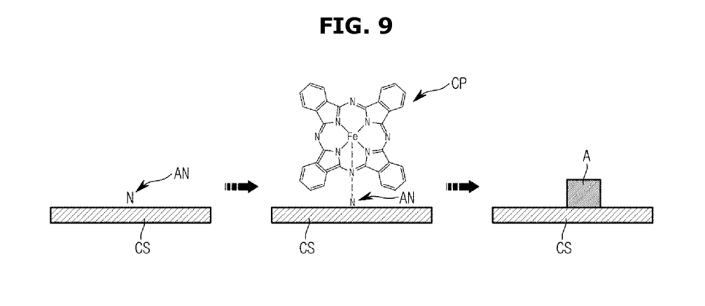

FIG. 8 is a diagram schematically illustrating reaction taking place on the surface of a pore of the porous carbon into which an anchoring site is not introduced. FIG. 9 is a diagram schematically illustrating reaction taking place on the surface of a pore of the porous carbon into which an anchoring site is introduced.

Referring to FIG. 8, if the anchoring sites are not formed on the pore surfaces CS of the porous carbon, weak interactions between carbon particles on the pore surfaces CS and the non-noble metal-based catalyst precursors CP may decrease a probability of catalytic active site formation. In this case, transition metal particles MP may be formed on the pore surfaces CS of the porous carbon with the laps of time. These transition metal particles MP may be eluted during an acidic solution treatment, which will be described later.

Referring to FIG. 9, if the anchoring sites AN are formed on the pore surfaces CS of the porous carbon, the anchoring sites AN may enhance interactions between carbon particles on the pore surfaces CS and the non-noble metal-based catalyst precursors CP. In other words, agglomeration of the non-noble metal-based catalyst precursors CP may be prevented by enhancing interactions between the carbon particles and the non-noble metal-based catalyst precursors CP by using the nitrogen atoms doped into the pore surfaces CS of the porous carbon as the anchoring sites AN. In addition, formation of the catalytic active sites A may be facilitated to increase the catalytic activity of the non-noble metal-based catalyst.

The non-noble metal catalytic active site A formed by the non-noble metal-based catalyst precursor and the anchoring site may be represented by Formula 1 below.

MₓN_{y} Formula 1

In Formula 1, x is an integer from 0 to 1, y is an integer from 1 to 4, and M is a transition metal such as iron (Fe), cobalt (Co), manganese (Mn), nickel (Ni), and chromium (Cr).

The structure of the non-noble metal-based catalyst used as a catalyst support of the hybrid catalyst for fuel cells according to an embodiment has been described above.

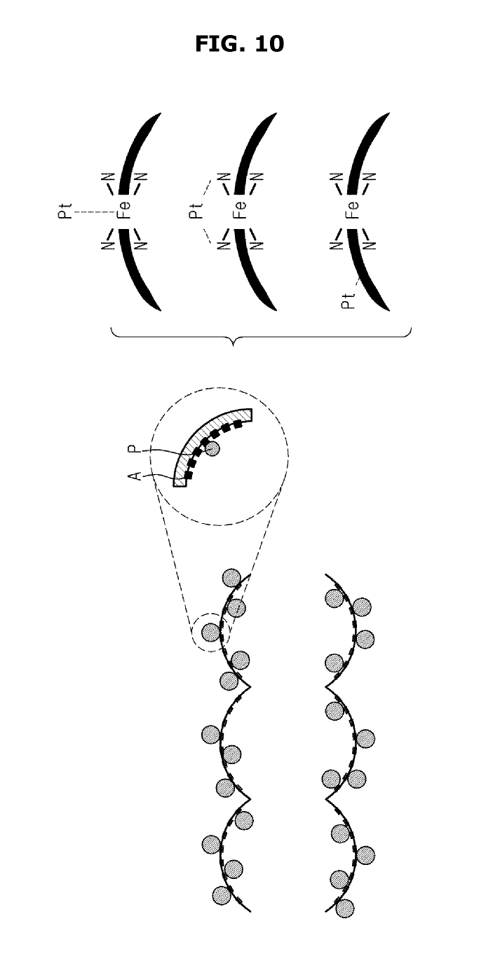

The present disclosure provides a supported catalyst in which the noble metal-based catalyst is supported on the non-noble metal-based catalyst. FIG. 10 is a diagram schematically illustrating a structure in which a noble metal-based catalyst is supported on a non-noble metal-based catalyst in a hybrid catalyst according to an embodiment.

Referring to FIG. 10, the noble metal-based catalyst may be supported around catalytic active sites of the non-noble metal-based catalyst.

The active sites of the non-noble metal-based catalyst are provided in the form of FeN₄ on the surface of the porous carbon as described above. Platinum (Pt) atoms may form the catalytic active sites on the surface of the porous carbon according to the following method.

Particularly, Pt atoms may form catalytic active sites via interactions with Fe atoms, via interactions with hetero atoms of nitrogen atoms, or interactions with carbon atoms in the same manner as in conventional catalysts.

As a result, the non-noble metal catalytic active sites formed by the non-noble metal-based catalyst precursor coexist with the catalytic active sites formed by the Pt atoms on the surface of the porous carbon. Therefore, according to the present disclosure, the same catalytic activity may be obtained using a less amount of the Pt catalyst in comparison with conventional catalysts.

The structure of the hybrid catalyst according to an embodiment has been described. Hereinafter, a method for manufacturing the hybrid catalyst will be described.

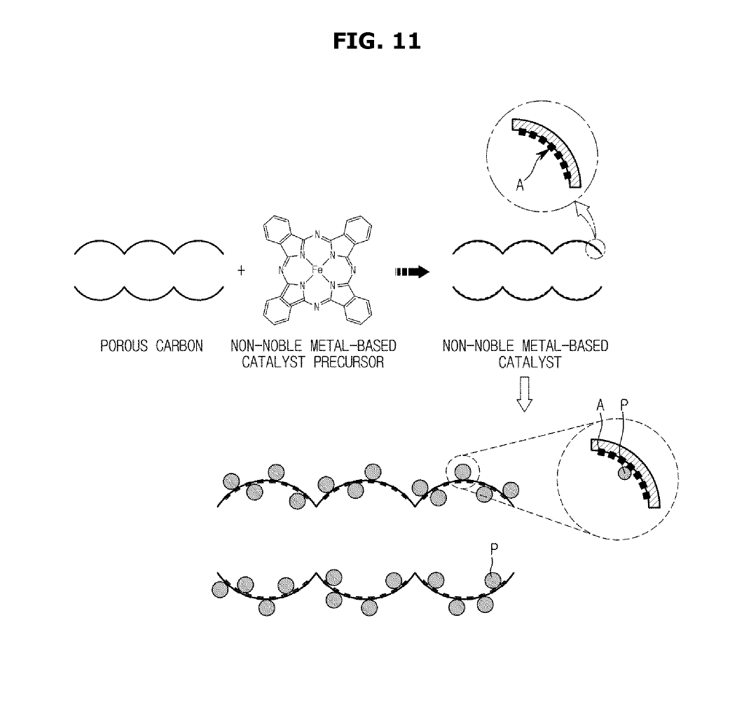

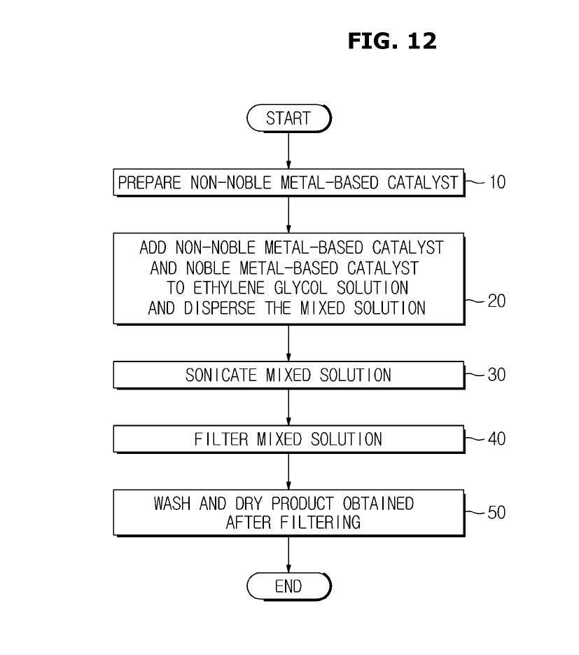

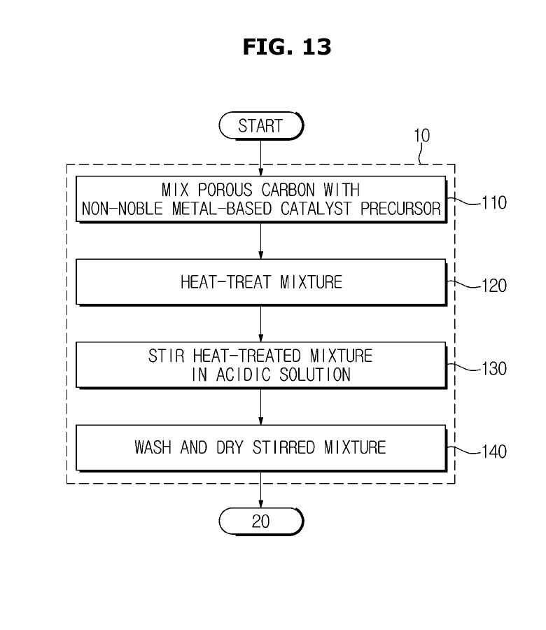

FIG. 11 is a schematic diagram illustrating a process of manufacturing a hybrid catalyst according to an embodiment. FIGS. 12 and 13 are flowcharts for describing the process of manufacturing the hybrid catalyst.

Referring to FIGS. 11 and 12, the process of manufacturing the hybrid catalyst according to an embodiment includes preparing a non-noble metal-based catalyst, dispersing a mixed solution prepared by adding the non-noble metal-based catalyst and a noble metal-based catalyst to an ethylene glycol solution, sonicating the mixed solution, filtering the mixed solution, and washing and drying a product acquired after the filtering.

First, the non-noble metal-based catalyst is prepared (10).

Referring to FIG. 13, the non-noble metal-based catalyst may be prepared by mixing a porous carbon with a non-noble metal-based catalyst precursor (110), heat-treating the mixture (120), stirring the heat-treated mixture in an acidic solution (130), and washing and drying the stirred mixture (140).

First, the mixing of the porous carbon with the non-noble metal-based catalyst precursor includes preparing the porous carbon and mixing the porous carbon with the non-noble metal-based catalyst precursor (110).

The preparation of the porous carbon may include a process of synthesizing MSUFC. The process of synthesizing MSUFC is as follows.

First, 9 mL of furfuryl alcohol is mixed with 6 g of AIMSUF-Si while adding the furfuryl alcohol by small quantities at a time, and the mixture is maintained at room temperature in a vacuum for 30 minutes. Then, the vacuum state is maintained in an oven at 85° C. for 8 hours. Solid powder obtained therefrom is carbonized in an inert gas atmosphere at 850° C. for 2 hours. The carbonization is performed by increasing the temperature to 600° C. at a rate of 1° C./min and to 850° C. at a rate of 5° C./min. Then, the carbonized solid powder is added to a 2 M sodium hydroxide (NaOH) solution and the mixture is stirred while being heated in boiling water at 80° C. for 6 hours. Then, the resultant mixture is washed using distilled water under a reduced pressure until the resultant has a neutral pH and dried to obtain MSUFC.

However, the aforementioned method is an example of synthesizing MSUFC, and any other methods obvious to one of ordinary skill in the art may also be used therefor.

Upon completion of the synthesis of MSUFC, the porous carbon and the non-noble metal-based catalyst precursor are mixed.

Types of the non-noble metal-based catalyst precursor available during the mixing process of the porous carbon and the non-noble metal-based catalyst precursor are as described above. In this regard, the activity of oxygen reduction reaction is influenced by the types of the non-noble metal-based catalyst precursor. Hereinafter, test results of the activity of oxygen reduction reaction depending on types of the non-noble metal-based catalyst precursor will be described for better understandings.

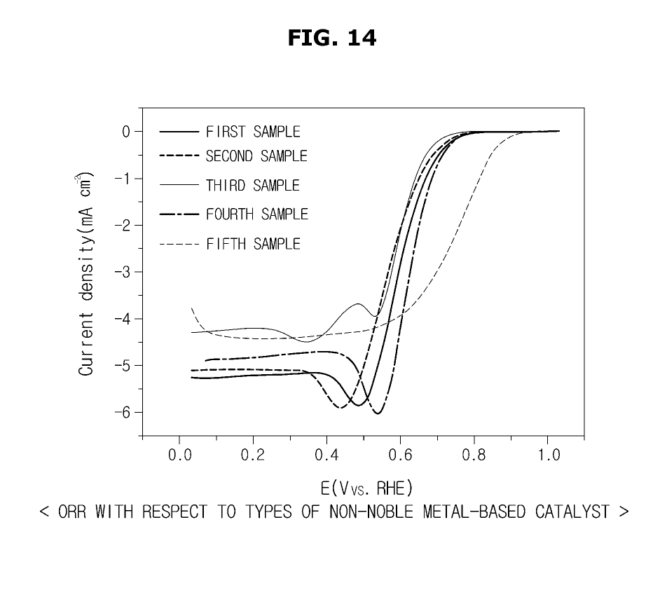

FIG. 14 is a graph illustrating results of oxygen reduction reaction (ORR) with respect to the types of the non-noble metal-based catalyst precursor.

FIG. 14 illustrates ORR results of first to fifth samples measured using a 0.5 M oxygen-saturated sulfuric acid (H₂SO₄) solution, a non-noble metal-based catalyst in a loading amount of 815 μg/cm², and 40 wt % Pt/C in a loading amount of 16 μgpt/cm² at 1600 rpm.

In this regard, the first sample is a non-noble metal-based catalyst sample using iron phthalocyanine as the non-noble metal-based catalyst precursor, the second sample is a non-noble metal-based catalyst sample using iron phenanthroline as the non-noble metal-based catalyst precursor, the third sample is a non-noble metal-based catalyst sample using vitamin B12 as the non-noble metal-based catalyst precursor, the fourth sample is a non-noble metal-based catalyst sample using 5,10,15,20-tetrakis(4-methoxyphenyl)-21H,23H-porphine iron (III) chloride as the non-noble metal-based catalyst precursor, and the fifth sample is a supported catalyst in which platinum (Pt) is supported on carbon.

As a result of analyzing half-wave potentials measured at −3 mA/cm² based on the graph of FIG. 14, it is confirmed that the fifth sample has the highest half-wave potential, and the half-wave potential decreases in the order of the fourth sample, the first sample, the third sample, and the second sample. As the half-wave potential increases, the catalytic activity increases. Therefore, it may be confirmed that the fifth sample using the platinum catalyst has the highest catalytic activity.

It is also confirmed that the half-wave potentials of the first to fourth samples using the non-noble metal-based catalyst precursors are just slightly lower than the half-wave potential of the fifth sample. Thus, it may be confirmed that non-noble metal-based catalysts having relatively excellent catalytic activity may be obtained using the non-noble metal-based catalyst precursors with lower manufacturing costs therefor.

Here, the amount of the non-noble metal-based catalyst precursor may be adjusted such that the mass fraction of the transition metal contained in the non-noble metal-based catalyst precursor is in the range of 1 to 50 w % based on the total weight of the porous carbon in the mixing of the porous carbon with the non-noble metal-based catalyst precursor. The significance of the mass fraction range of the transition metal added to the porous carbon is as described above, and descriptions presented above will not be repeated herein.

The mixing of the porous carbon with the non-noble metal-based catalyst precursor according to an embodiment may include introducing anchoring sites into the porous carbon. This process may be performed to enhance interactions between the porous carbon and the non-noble metal-based catalyst precursor. However, this process may be dispensed with.

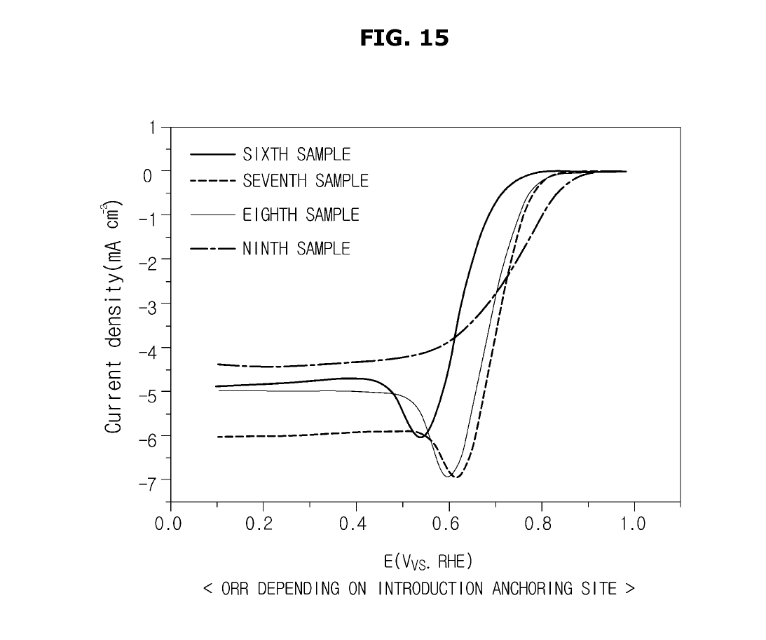

FIG. 15 is a graph illustrating results of ORR depending on introduction of anchoring sites.

FIG. 15 illustrates ORR results of sixth to ninth samples measured using a 0.5 M oxygen-saturated H₂SO₄ solution, a non-noble metal-based catalyst in a loading amount of 815 μg/cm², and 40 wt % Pt/C in a loading amount of 16 μgpt/cm² at 1600 rpm.

In this regard, the sixth sample is a non-noble metal-based catalyst sample using 5,10,15,20-tetrakis(4-methoxyphenyl)-21H,23H-porphine iron(III) chloride as the non-noble metal-based catalyst precursor, the seventh sample is a non-noble metal-based catalyst sample using iron phthalocyanine as the non-noble metal-based catalyst precursor after introducing anchoring sites into the porous carbon, the eighth sample is a non-noble metal-based catalyst sample using 5,10,15,20-tetrakis(4-methoxyphenyl)-21H,23H-porphine iron (III) chloride as the non-noble metal-based catalyst precursor after introducing anchoring sites into the porous carbon, and the ninth sample is a supported catalyst in which Pt is supported on carbon.

As a result of analyzing half-wave potentials measured at −3 mA/cm² based on the graph of FIG. 15, it is confirmed that the seventh sample has the highest half-wave potential, and the half-wave potential decreases in the order of the eighth sample, the ninth sample, and the sixth sample.

Particularly, upon comparison between the sixth sample and the eighth sample, it is confirmed that the eighth sample having anchoring sites introduced into the porous carbon using nitrogen has far higher catalytic activity than the sixth sample with no anchoring sites. Also, the catalytic activity of the seventh and eighth samples is higher than that of the ninth sample using the noble metal catalyst. Thus, it may be confirmed that a decrease in the catalytic activity caused by using the non-noble metal-based catalyst may be prevented by introducing the anchoring sites.

After the porous carbon is mixed with the non-noble metal-based catalyst precursor, the mixture may be heat-treated (120).

The mixture may be heat-treated at a temperature of 600 to 1200° C. in an inert gas atmosphere for approximately 10 to 300 minutes. Here, types of the inert gas may include argon (Ar), nitrogen (N₂), helium (He), and neon (Ne), without being limited thereto.

If a heat-treatment temperature is lower than 600° C., the catalytic active sites are not efficiently formed on the surface of the porous carbon. If the heat-treatment temperature is higher than 1200° C., the structure of the porous carbon may easily break. Since performance of ORR is influenced by the heat-treatment temperature in the range of 600° C. to 1200° C., the heat-treatment conditions may be adjusted appropriately depending on desired activity of the non-noble metal-based catalyst. Variation of the catalytic activity depending on the heat-treatment conditions will be described later.

After the mixture is heat-treated, the heat-treated mixture is added to an acidic solution and the resultant mixture is stirred (130).

This process is performed to remove inactive transition metal compounds.

The stirring of the heat-treated mixture in an acidic solution may include adding the heat-treated mixture to an inorganic acidic solution having a concentration of 0.1 M or greater and stirring the resultant mixture at room temperature. Types of the inorganic acidic solution may include a 0.5 M H₂SO₄ solution, without being limited thereto.

Here, the acidic solution may have a concentration of 0.1 M or greater. If the concentration of the acidic solution is less than 0.1 M, it may be difficult to sufficiently remove the inactive transition metal compounds. Thus, the concentration of the acidic solution may be appropriately controlled, if required.

After the mixture is stirred in the acidic solution, the stirred mixture may be washed and dried (140).

This process may include continuously washing the mixture using distilled water under a reduced pressure until the resultant has a neutral pH and then drying the washed mixture.

After the stirred mixture is washed and dried, solid powder obtained therefrom may further be heat-treated in an ammonia (NH₃) gas atmosphere. In general, a carbon network of porous carbon has defects. As nitrogen is introduced into the defects of the porous carbon, the catalytic activity may further be enhanced.

This process may include heat-treating the solid powder at a temperature of 600 to 1200° C. in an ammonia gas atmosphere for 5 to 60 minutes.

If the heat-treatment temperature is less than 600° C., the surface of the non-noble metal-based catalyst may not be efficiently doped with nitrogen. If the heat-temperature is greater than 1200° C., the structure of the porous carbon may easily break. Also, if a heat-treatment time is less than 5 minutes, the surface of the non-noble metal-based catalyst is not sufficiently doped with nitrogen. If the heat-treatment time is greater than 60 minutes, the structure of the non-noble metal-based catalyst may easily break. Thus, the heat-treatment temperature and the heat-treatment time need to be appropriately adjusted to efficiently introduce nitrogen into the surface of the porous carbon.

Hereinafter, variation of the catalytic activity in accordance with the heat-treatment conditions will be described with reference to the accompanying drawings. Heat-treatment conditions in operations 120 and 140 will be described in more detail based on the following experiments.

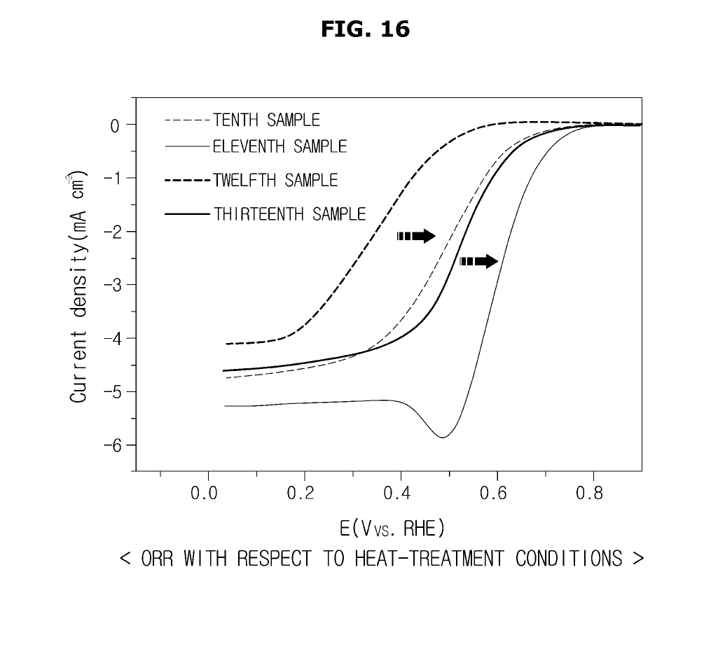

FIG. 16 is a graph illustrating results of ORR with respect to heat-treatment conditions.

FIG. 16 illustrates ORR results of tenth to thirteenth samples measured using a 0.5 M oxygen-saturated H₂SO₄ solution and a non-noble metal-based catalyst in a loading amount of 815 μg/cm² at 1600 rpm.

In this regard, the tenth to thirteenth samples are non-noble metal-based catalyst samples using iron phthalocyanine and heat-treated under different heat-treatment conditions. Particularly, the tenth sample is a non-noble metal-based catalyst sample heat-treated at 900° C. in an argon gas atmosphere for 60 minutes. The eleventh sample is a non-noble metal-based catalyst sample heat-treated at 900° C. in an argon gas atmosphere for 60 minutes, and then further heat-treated at 950° C. in an ammonia gas atmosphere for 15 minutes. The twelfth sample is a non-noble metal-based catalyst sample heat-treated at 1050° C. in an argon gas atmosphere for 60 minutes. The thirteenth sample is a non-noble metal-based catalyst sample heat-treated at 1050° C. in an argon gas atmosphere for 60 minutes, and then further heat-treated at 950° C. in an ammonia gas atmosphere for 15 minutes.

As a result of analyzing half-wave potentials measured at −3 mA/cm² based on the graph of FIG. 16, it may be confirmed that the tenth sample heat-treated at 900° C. has better catalytic activity than the twelfth sample heat-treated at 1050° C. Moreover, it may also be confirmed that the catalytic activity is further enhanced via the additional heat-treatment of the non-noble metal-based catalyst in the ammonia gas atmosphere based on comparison of the half-wave potentials between the tenth and eleventh samples and between the twelfth and thirteenth samples.

The method for preparing the non-noble metal-based catalyst illustrated in FIG. 12 has been described above.

After preparing the non-noble metal-based catalyst, the non-noble metal-based catalyst and the noble metal-based catalyst are added to the ethylene glycol solution and the mixed solution is dispersed (20).

To this end, first, the ethylene glycol solution is purged in an inert gas atmosphere.

For example, the purging of the ethylene glycol solution may include purging 20 to 100 mL of the ethylene glycol solution in an inert gas atmosphere for 30 minutes or longer to support 30 wt % of Pt on the non-noble metal-based catalyst support using a sonicator including an ultrasonic horn having a diameter of 12 mm.

In this case, if the amount of the ethylene glycol solution is less than 20 ml, Pt may not be appropriately supported due to an insufficient reducing agent. On the contrary, if the amount of the ethylene glycol solution is greater than 100 ml, Pt may not be appropriately supported since the intensity of ultrasound is offset due to a decreased concentration. Thus, the amount of the ethylene glycol solution may be appropriately adjusted. Here, the amount of the ethylene glycol solution described above is determined based on the diameter (12 mm) of the ultrasonic horn of the sonicator to support 30 wt % of Pt on the non-noble metal-based catalyst support. Thus, the amount of the ethylene glycol solution may vary in accordance with a desired amount of the supported Pt.

Next, the non-noble metal-based catalyst is added to the ethylene glycol solution and dispersed, and then the non-noble metal-based catalyst precursor is added thereto and dispersed.

The non-noble metal-based catalyst may include the transition metal contained in the non-noble metal catalytic active sites in a mass fraction of 1 to 50 wt % based on the total weight of the porous carbon.

The noble metal-based catalyst may include at least one of platinum (Pt), palladium (Pd), iridium (Ir), and gold (Au) as described above. For example, if the noble metal-based catalyst is a Pt catalyst, the Pt catalyst may be provided in the form of Pt(acetyl acetate)₂ and exists in a Pt²⁺ state.

After adding the non-noble metal-based catalyst and the noble metal-based catalyst to the ethylene glycol solution and dispersing the mixed solution, the mixed solution is sonicated (30).

The sonicating of the mixed solution may be performed by ultrasonication-associated polyol synthesis (UPS).

For example, an ultrasonic horn having a diameter of 12 mm is installed in a reaction chamber, and ultrasound having an output power of 500 W at a maximum frequency of 20 kHz is applied by 20 to 40% to the mixed solution for about 1 to 3 hours.

If the intensity of ultrasound is less than 20% of the maximum output power, the reducing power is weak so that Pt particles may not be loaded by the target loading amount of 30 wt %. On the contrary, if the intensity of ultrasound is greater than 40% of the maximum output power, the temperature exceeds a reduction temperature of 160° C. causing agglomeration of particles, thereby reducing the catalytic activity. Thus, the intensity of ultrasound applied thereto may be appropriately adjusted.

If ultrasound is applied for less than 1 hour, Pt particles may not be sufficiently reduced due to insufficient reaction time. On the contrary, if ultrasound is applied for longer than 3 hours, excess heat may cause agglomeration of Pt particles. Thus, ultrasound application time may be appropriately adjusted.

After sonicating the mixed solution, the mixed solution is filtered (40).

The mixed solution may be filtered by membrane filtration using a Nafion membrane.

Then, the filtered product is washed and dried (50).

This process is performed by using 1 L of each of ethanol (EtOH) and distilled water (DI-water) and DI-water is used during a final process to prevent ignition.

Then, the resultant is maintained in a dry oven at 30° C. and dried for half-day to obtain a hybrid catalyst.

The method for manufacturing the hybrid catalyst has been described.

The hybrid catalyst according to an embodiment may have active sites formed only on the surfaces of micro pores among the pores of the porous carbon by controlling manufacturing conditions while manufacturing the non-noble metal-based catalyst as described above. Thus, utilization of the catalytic active sites increases since reactants may easily approach the catalytic active sites in an actual driving environment. Also, since the non-noble metal-based catalyst is used as a support of the Pt catalyst, the hybrid catalyst may have excellent catalytic activity despite a less amount of the Pt catalyst.

Hereinafter, effects of the positions of the catalytic active sites on enhancing utilization of the catalytic active sites will be described.

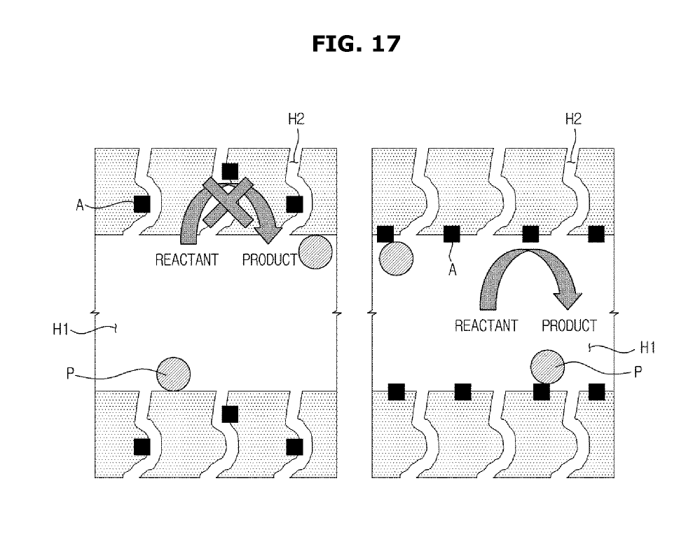

If a non-noble metal catalytic active site A is formed in a second pore H2 that is an ultrafine pore as illustrated in a left diagram of FIG. 17, a reactant cannot easily approach the catalytic active site A, and thus functions of the catalytic active site A may not be efficiently performed. Also, since the Pt catalyst exists only in a form bonded to carbon atoms of the porous carbon, a loading amount of the catalyst increases to obtain the same effect.

On the contrary, in the hybrid catalyst according to an embodiment, the non-noble metal catalytic active site A of the non-noble metal-based catalyst serving as a support of the Pt catalyst is formed on the surface of the first pore H1 that is a micropore as illustrated in a right diagram of FIG. 17. Thus, functions of the catalytic active site A may be efficiently performed. Also, since the Pt catalyst exists in the form bonded to metal atoms or nitrogen atoms of the non-noble metal catalytic active sites A as well as bonded to carbon atoms of the porous carbon, the non-noble metal-based catalyst may have excellent catalytic activity despite a less amount of the noble metal-based catalyst.

Hereinafter, CV curves and ORR curves of catalysts will be described to verify the catalytic activity of the hybrid catalyst according to the present disclosure.

In order to verify the catalytic activity of the hybrid catalyst according to the present disclosure, catalyst samples were prepared according to Example 1 and Comparative Examples 1 and 2 below.

### Comparative Example 1

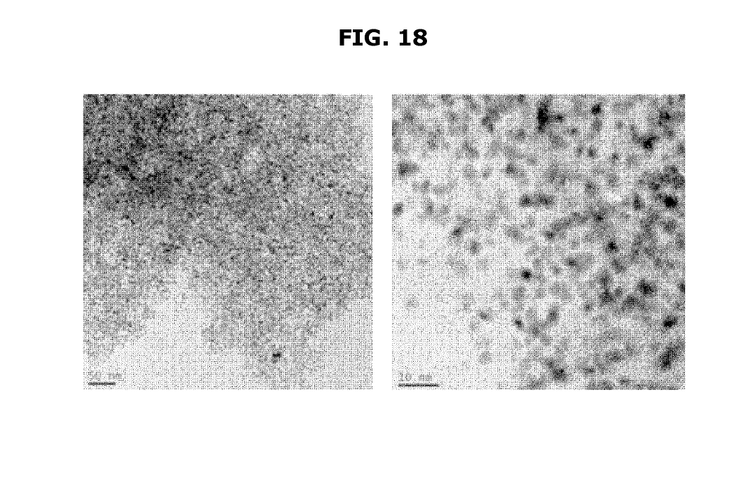

A commercially available Pt catalyst sample Pt/C was prepared by supporting 46.5% of Pt particles on porous carbon (MSUFC). A TEM image of the catalyst sample according to Comparative Example 1 is shown in FIG. 18.

### Comparative Example 2

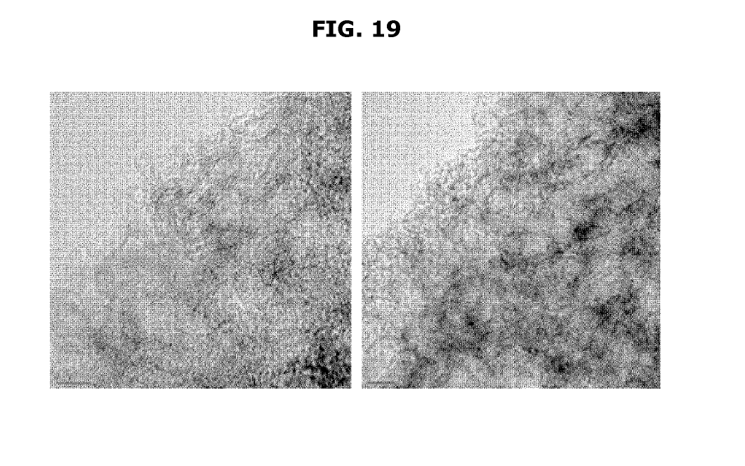

A non-noble metal-based catalyst sample N-FePhth was prepared by introducing anchoring sites into porous carbon (MSUFC) and using iron phthalocyanine as a non-noble metal-based catalyst precursor. A TEM image of the non-noble metal-based catalyst sample according to Comparative Example 2 is shown in FIG. 19.

### Example 1

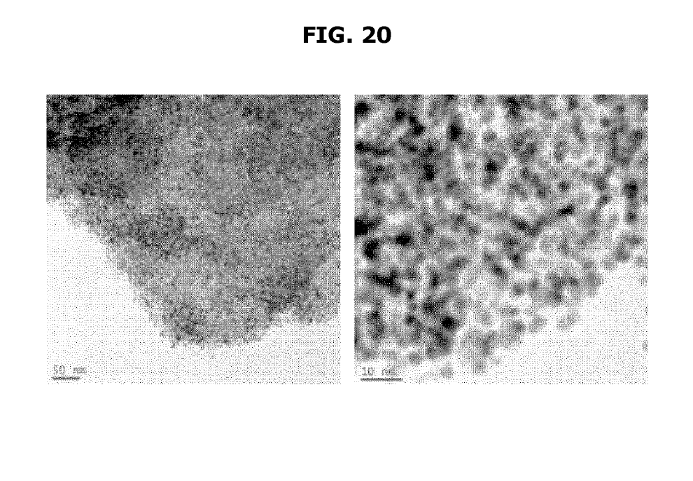

A hybrid catalyst sample was prepared by supporting a Pt catalyst on the non-noble metal-based catalyst sample prepared according to Comparative Example 2. Particularly, 30 ml of ethylene glycol was purged in an argon and nitrogen atmosphere for 30 minutes. 200 mg of the non-noble metal-based catalyst sample N-FePhth prepared according to Comparative Example 2 was dispersed in the ethylene glycol solution, and then 353.95 mg (0.6 mmol) of Pt(acetyl acetate)₂ was added thereto and dispersed. Then, an ultrasonic horn having a diameter of 12 mm was installed in a reaction chamber, and ultrasound is applied to the mixed solution with an intensity of 30% of the maximum frequency of 20 kHz. Then, the solution was filtered, and a product obtained after filtering was washed and dried to obtain a hybrid catalyst Pt/N-FePhth in which 32% of the Pt catalyst is supported on the N-FePhth support. A TEM image of the hybrid catalyst sample according to Example 1 is shown in FIG. 20.

The amount of the Pt catalyst contained in the hybrid catalyst Pt/N-FePhth was analyzed by inductively coupled plasma atomic emission spectroscopy (ICP-AES) and is shown in Table 1 below.

TABLE 1

| | Catalyst | Final conc (mg/kg) | Final conc (%) |
|---|---|---|---|
| Pt | Pt/N—FePhth | 323784 | 32.38 |

It was confirmed that approximately 32 wt % of the Pt catalyst was loaded based on the ICP-AES results.

Electrochemical properties of the catalysts prepared according to Example 1 and Comparative Examples 1 and 2 were evaluated as follows to measure the catalytic activity of the catalysts.

Experimental Example: Analysis of Electrochemical Properties

Cyclic Voltammetry (CV) analysis was performed using a three-electrode system electrochemical cell including a glassy carbon electrode (GCE) having a diameter of 3 mm as a working electrode, a Pt wire as a counter electrode, and a saturated calomel electrode (SCE) as a reference electrode. Electrochemical properties of standard hydrogen electrodes (SHE) were analyzed. An ink was prepared using 5 wt % of a Nafion solution, based on the catalyst, and an IPA solution, and the mixed solution was dispersed by sonication for 5 to 10 minutes. Then, 5 μl of an ink slurry was dropped on the glassy carbon electrode having a diameter of 5 mm (0.196 cm²) by using a micropipette. ORR was measured at a scan rate 5 to 10 mV/s using an oxygen-saturated 0.1 M HClO₄.

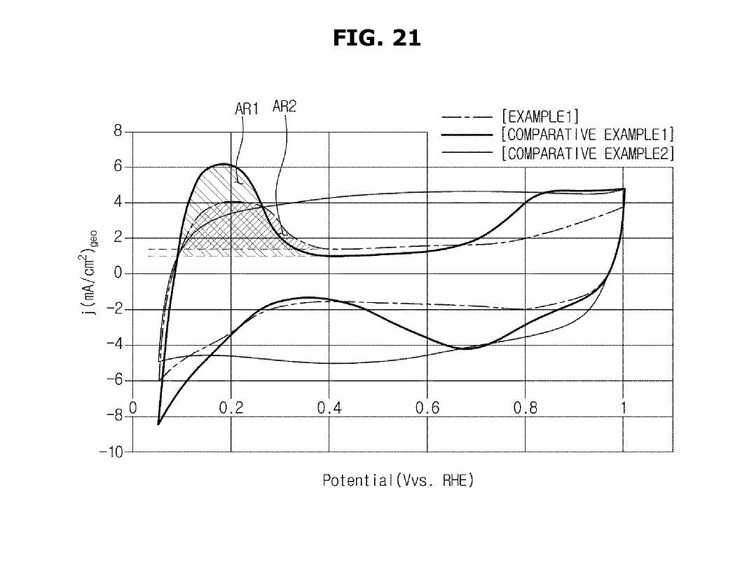

FIG. 21 is a graph illustrating cyclic voltammetry curves of the catalysts prepared according to Example 1 and Comparative Examples 1 and 2.

The CV curves of FIG. 21 show adsorption and desorption peaks of hydrogen molecules with respect to the Pt catalyst obtained in a voltage range of 0.05 to 1 V indicating the existence of the Pt catalyst.

Particularly, referring to the CV curve of the catalyst of Comparative Example 1, a hydrogen desorption peak is identified at around 0.2 V. An area AR1 of FIG. 21 is an electrochemical surface area (ECSA) of the Pt/C catalyst according to Comparative Example 1. In general, as ECSA increases, the catalytic activity increases. Thus, it may be confirmed that the Pt/C catalyst according to Comparative Example 1 has a high catalytic activity.

Referring to the CV curve of Example 1, a hydrogen desorption peak is also observed at around 0.2 V, and it is confirmed that desired Pt particles are appropriately supported. An area AR2 of FIG. 21 is an ESCA of the catalyst according to Example 1. Since the sizes of Pt particles are 3-5 nm in both the commercially available Pt/C catalyst and the hybrid catalyst Pt/N-FePhth, the results were sensible taking the loading amount difference approximately of 15 wt % into consideration.

Referring to the CV curve of Comparative Example 2, a hydrogen desorption peak was not observed in the non-Pt catalyst N-Phth, since the Pt was not included therein. Upon comparison of the CV curve of Comparative Example 2 with the CV curves of Example 1 and Comparative Example 1, it is confirmed that an electric double layer of Comparative Example 2 was thicker than those of Example 1 and Comparative Example 1. This is because the non-Pt catalyst has a high electron-holding ability since non-metallic catalytic active sites FeN₄ are formed in carbon.

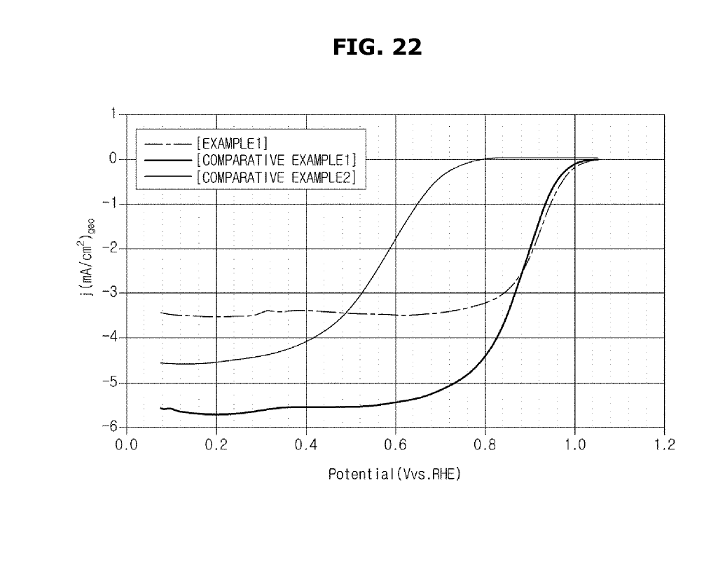

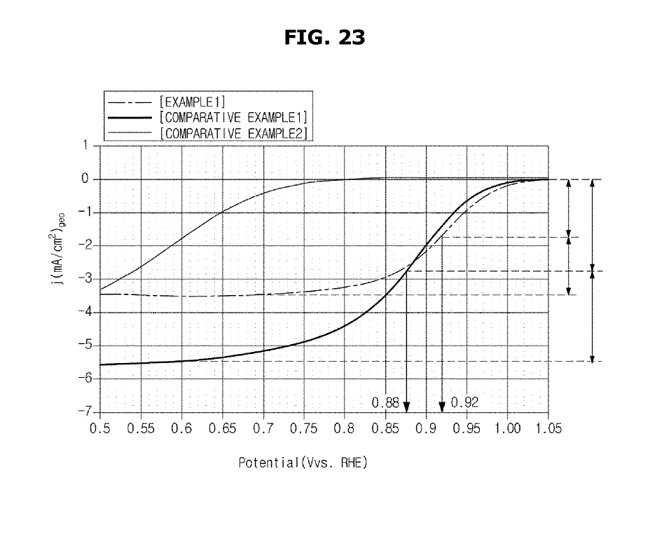

FIGS. 22 and 23 are graphs illustrating ORR curves of the catalysts prepared according to Example 1 and Comparative Examples 1 and 2. FIG. 23 illustrates an enlarged portion of the ORR graph of FIG. 22 to calculate half-wave potentials.

Among indices of evaluating catalytic activities, half-wave potential (E_{1/2}) is used as an index of evaluating the activity of the catalyst for ORR by linear sweep voltammetry (LSV) using a rotating disc electrode.

Half-wave potential refers to a potential corresponding to a current density at a half point between an onset potential and a limiting current. A larger number of electrons generated indicates a higher half-wave potential. As the half-wave potential increases, the catalytic activity increases.

Referring to FIGS. 22 and 23, the Pt/C catalyst according to Comparative Example 1 has a half-wave potential of 0.92 V, and the non-Pt catalyst N-FePhth according to Comparative Example 2 has a half-wave potential of 0.52 V, and the hybrid catalyst Pt/N-FePhth according to Example 1 has a half-wave potential of 0.88 V.

Although the hybrid catalyst Pt/N-FePhth according to Example 1 has a less loading amount of the Pt catalyst than that of commercially available catalysts approximately by 15 wt % and a smaller electrochemically active surface area than those of the commercially available catalysts, the half-wave potential of the hybrid catalyst Pt/N-FePhth is greater than those of the commercially available catalyst by 0.04 V. Thus, it may be confirmed that the hybrid catalyst according to an embodiment has the same catalytic activity using a less amount of the Pt catalyst.

As apparent from the above description, the following effects may be obtained according to the hybrid catalyst for fuel cells and the method for manufacturing the same according to an embodiment.

First, since the non-noble metal-based catalyst having catalytic active sites are used as a support of the Pt catalyst, the same catalytic activity may be obtained using a less amount of the Pt catalyst than that of conventional catalysts.

Also, since a reactant easily approaches to the active sites in an actual driving environment by forming the active sites only on the surfaces of the micro pores among the pores of the porous carbon by adjusting manufacturing conditions for the non-noble metal-based catalyst used as the support of the Pt catalyst, utilization of the catalytic active site may be improved. As a result, the hybrid catalyst may have excellent catalytic activity despite a less amount of the Pt catalyst.

Furthermore, since a nanoporous carbon having a uniform structure including large pores is used during the manufacturing process of the non-noble metal-based catalyst, excellent catalytic performance may be obtained by reducing mass transfer resistance in MEAs. As a result, the hybrid catalyst may have excellent catalytic activity despite a less amount of the Pt catalyst.

In addition, since interactions between the porous carbon and the non-noble metal-based catalyst precursor are enhanced by introducing anchoring sites into the surface of the porous carbon used to manufacture the non-noble metal-based catalyst, the non-noble metal-based catalytic activity may be increased. As a result, the hybrid catalyst may have excellent catalytic activity despite a less amount of the Pt catalyst.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A hybrid catalyst for a fuel cell comprising:
a noble metal-based catalyst; and
a non-noble metal-based catalyst on which the noble metal-based catalyst is supported.

2. The hybrid catalyst according to claim 1, wherein the noble metal-based catalyst comprises at least one of platinum (Pt), palladium (Pd), iridium (Ir), and gold (Au).

3. The hybrid catalyst according to claim 1, wherein the non-noble metal-based catalyst comprises a porous carbon having a first pore and a second pore smaller than the first pore,
wherein the first pore has a pore size of 5 to 100 nm, and a non-noble metal catalytic active site is introduced into an inner wall of the first pore.

4. The hybrid catalyst according to claim 3, wherein the noble metal-based catalyst is supported on the surface of the first pore of the non-noble metal-based catalyst.

5. The hybrid catalyst according to claim 3, wherein the porous carbon has a structure in which the first pore and the second pore are uniformly connected in a three-dimensional space.

6. The hybrid catalyst according to claim 3, wherein the first pore has a pore size of 15 to 60 nm.

7. The hybrid catalyst according to claim 3, wherein the non-noble metal catalytic active site is represented by Formula 1 below:
MₓN_{y} Formula 1
wherein x is an integer from 0 to 1, y is an integer from 1 to 4, and M is a transition metal.

8. The hybrid catalyst according to claim 3, wherein the non-noble metal catalytic active site is formed by a non-noble metal-based catalyst precursor.

9. The hybrid catalyst according to claim 8, wherein the non-noble metal-based catalyst precursor has a form in which at least one of phthalocyanine, phthalocyanine tetrasulfonate, octabutoxy phthalocyanine, hexadecafluoro phthalocyanine, octakis octyloxy phthalocyanine, tetra-tert-butyl phthalocyanine, tetraaza phthalocyanine, tetraphenoxy phthalocyanine, tetra-tert-butyl tetrakis dimethylamino phthalocyanine, tetrakis cumylphenoxy phthalocyanine, tetrakis pyridiniomethyl phthalocyanine, tetranitrophthalocyanine, naphthalocyanine, tetra-tert-butyl naphthalocyanine, tetraphenyl porphine, tetrakis pentafluorophenyl porphyrin, tetrakis methylpyridinio porphyrin tetratoluenesulfonate, tetrakistrimethylammoniophenyl porphyrin tetratoluenesulfonate, tetramethyl divinyl porphinedipropionic acid, tetrapyridyl porphine, octaethyl porphyrin, tetrakis methoxyphenyl porphine, tetraphenylporphine tetracarboxylic acid, tetrakis hydroxyphenyl porphine, tetrakis sulfonatophenyl porphine, etioporphyrin, 1,10-phenanthroline, 1,10-phenanthroline-5,6-dionedimethyl-1,10-phenanthroline, dimethyl-1,10-phenanthroline, dimethoxy-1,10-phenanthroline, dimethoxy-1,10-phenanthroline, amino-1,10-phenanthroline, methyl-1,10-phenanthroline, dihydroxy-1,10-phenanthroline, tetramethyl-1,10-phenanthroline, chloro-1,10-phenanthroline, dichloro-1,10-phenanthroline, nitro-1,10-phenanthroline, bromo-1,10-phenanthroline, tetrabromo-1,10-phenanthroline, pyrazino[1,10]phenanthroline, diphenyl-1,10-phenanthroline, dimethyl diphenyl-1,10-phenanthroline, ethenyl formyl(hydroxy trimethyltetradecyl) trimethyl porphine dipropanoato, diethenyl tetramethyl porphine dipropanoato, bis((amino carboxyethyl)thio)ethyl tetramethyl porphine dipropanoato, dihydro dihydroxy tetramethyl divinyl porphine dipropionic acid lactonato, ethenyl(hydroxy trimethyl tetradecatrienyl) tetramethyl porphine dipropanoato, carboxyethenyl carboxyethyl dihydro bis(hydroxymethyl) tetramethyl porphine dicarboxylato, dimethylbenzimidazolyl)cyanocobamide, curtis macrocycle, Jäger macrocycle and DOTA macrocycle, is coordinated to a metal.

10. The hybrid catalyst according to claim 9, wherein the metal includes at least one transition metal selected from iron (Fe), cobalt (Co), manganese (Mn), nickel (Ni), and chromium (Cr).

11. The hybrid catalyst according to claim 8, wherein a mass fraction of the transition metal comprised in the non-noble metal-based catalyst precursor is in the range of 1 to 50 wt % based on a total weight of the porous carbon.

12. The hybrid catalyst according to claim 8, wherein an anchoring site is introduced into a surface of a pore of the porous carbon to enhance interactions between the porous carbon and the non-noble metal-based catalyst precursor.

13. A method for manufacturing a hybrid catalyst for fuel cells, the method comprising steps of:
adding a non-noble metal-based catalyst and a noble metal-based catalyst to an ethylene glycol solution and dispersing a mixed solution; and
sonicating the mixed solution.

14. The method according to claim 13, further comprising a step of purging the ethylene glycol solution in an inert gas atmosphere.

15. The method according to claim 13, wherein the step of adding the non-noble metal-based catalyst and the noble metal-based catalyst to the ethylene glycol solution and dispersing the mixed solution comprises steps of:
adding a non-noble metal-based catalyst to an ethylene glycol solution and dispersing a mixture thereof, and adding a noble metal-based catalyst to the mixture and dispersing a resultant mixture thereof.

16. The method according to claim 13, wherein the step of sonicating of the mixed solution comprises sonicating the mixed solution for 1 to 3 hours.

17. The method according to claim 13, further comprising steps of:
filtering the mixed solution; and
washing and drying a filtered product.

18. The method according to claim 13, further comprising a step of preparing the non-noble metal-based catalyst,
wherein the step of preparing the non-noble metal-based catalyst comprises steps of:
mixing a porous carbon with a non-noble metal-based catalyst precursor;
heat-treating a mixture thereof at a temperature of 600 to 1200° C.;
stirring the heat-treated mixture in an acidic solution; and
washing and drying the stirred mixture.

19. The method according to claim 18, further comprising a step of forming an anchoring site on a surface of a pore of the porous carbon by heat-treating the porous carbon in an ammonia (NH₃) gas atmosphere at a temperature of 600 to 1200° C. for 5 to 60 minutes.

20. The method according to claim 18, wherein the step of stirring the heat-treated mixture in the acidic solution comprises a step of adding the heat-treated mixture to an acidic solution having a concentration of 0.1 M or greater and stirring the resultant mixture.
